(19) United States
(12) Patent Application Publication
(10) Pub. No.: US 2026/0014586 A1
(43) Pub. Date: Jan. 15, 2026

(54) COATING PROCESS FOR ENGINEERED-WOOD BOARDS, PLANKS, PANELS OR PICKETS

(71) Applicant: LOUISIANA-PACIFIC CORPORATION, NASHVILLE, TN (US)

(72) Inventors: HEIDI TURNER, NASHVILLE, TN (US); DALE BALDWIN, ELKIN, NC (US); CHAD WITHERSPOON, ELKIIN, NC (US); LARRY JOHNSON, WILKESBORO, TN (US)

(21) Appl. No.: 19/336,578

(22) Filed: Sep. 23, 2025

Related U.S. Application Data
(63) Continuation-in-part of application No. 16/992,002, filed on Aug. 12, 2020, now Pat. No. 12,420,305.
(60) Provisional application No. 62/885,383, filed on Aug. 12, 2019.
(60) Provisional application No. 62/885,383, filed on Aug. 12, 2019.

(51) Int. Cl. B05D 7/06; B05D 3/00; B05D 3/12; B05D 7/00

(52) U.S. Cl. CPC B05D 7/06; B05D 3/007; B05D 3/12; B05D 7/5383; B05D 2203/20; B05D 2252/00; B05D 2501/00

(57) ABSTRACT

An apparatus and method of applying a finish or paint coating in a prefinishing or finishing line to a siding piece, board, plank, panel, or fencing panel or picket that provides a two-tone paint effect on a face thereof or that disguises the screen-back texture of the engineered wood substrate. After paint or similar coating is applied (such as by one or more spray nozzles) to a face to a fence picket or fencing product or component, the fence picket passes under a roller, brush, or roller brush or similar paint applicator while the paint is still wet. The roller/brush removes some of the paint and applies an angled pattern to the face, which disguises the screen-back texture of the substrate. Alternatively, a paint redistribution apparatus is used to move and/or remove a portion of the topcoat of paint to allow portions of a basecoat to be seen.

This application is a continuation-in-part application of U.S. application Ser. No. 16/992,002, filed Aug. 12, 2020, issued as U.S. patent Ser. No. 12/420,305 on Sep. 23, 2025, which claims benefit of and priority to U.S. Provisional Application No. 62/885,383, filed Aug. 12, 2019; this application also claims priority to U.S. Provisional Application No. 63/885,925, filed Aug. 22, 2025; all of the above references are incorporated herein in their entireties by specific reference for all purposes.

### FIELD OF INVENTION

This invention relates to a coating process and system for engineered-wood siding boards, planks, pieces, or panels, or fence panels or pickets comprising engineered wood components.

### SUMMARY OF INVENTION

In several exemplary embodiments, the present invention comprises methods of applying a finish or paint coating in a finishing or prefinishing process for an engineered-wood siding board, plank, piece, or panel, or a fencing panel or picket (a reference to any one of these forms should be construed to include any and all of these forms). In one embodiment, the invention comprises a method that disguises the screen-back texture of a manufactured wood substrate. The boards, panels or pickets are conveyed on a line through one or more paint/coating machines or booths, where a paint or similar coating is applied by brush or spray application (e.g., by one or more spray nozzles), to one or more surfaces of the panel or picket. Paint/coating may be applied to a single surface or multiple surfaces at the same time, or at different times by the same booth/machine or via different booths or machines on the prefinishing line.

After paint or similar coating is applied (such as by one or more spray nozzles) to a face of the board, panel or picket, or other fencing product, (such as, for example, the screen-back patterned face on the manufactured wood substrate), the board, picket or panel passes under a roller brush while the paint is still wet. The roller brush removes some of the paint and applies a pattern to the face, which disguises the screen-back texture of the substrate. In several embodiments, no paint is previously applied to the brush; i.e., the brush is not used to apply paint to the picket, just remove some of the paint and apply a pattern to the remaining paint.

In several embodiments, the brush is angled with respect to the board, panel or picket. In one exemplary embodiment, the angle ranges from 0 degrees to approximately 45 degrees (with respect to a line across the width of the picket and/or finishing line, which is at right angles to the longitudinal axis of the board/panel/picket and/or finishing line). In a further exemplary embodiment, the angle ranges from approximately 10 degrees to approximately 25 degrees. In a preferred embodiment, the angle ranges from approximately 12 degrees to approximately 20 degrees. As a result, the brush applies a variable pattern at an angle along the length of the face, with minimal paint flow after brushing. The board/panel/picket may then pass through an oven or drying station to dry the paint and the pattern on the face.

In several embodiments, a blade or scraper may be positioned along the brush to remove excess paint from the brush as it removes paint from the picket face. The excess paint is metered off one end of the blade, and processed for re-use or disposal.

In another embodiment, boards, panels or planks are subject to two-toned processing in a different manner. The process first applies a base coat paint layer (by spraying or otherwise) of a first color in a first paint booth on a product face, which can be smooth or textured, such as the cedar or similar texture described above, then allows the basecoat to dry or be cured (if needed), and then applies a top coat paint layer (by spraying or otherwise) of a second color in a second paint booth over the base coat paint layer. While the top coat is still wet, the painted product then is conveyed into the paint redistribution apparatus, which moves all or substantially all of the topcoat paint from the high points or “peaks” of the textured surface and into the low points or “valleys” thereof, and/or removing portions of the topcoat from the product. The areas where the topcoat is removed expose the basecoat, thereby resulting in a two-tone appearance.

### BRIEF DESCRIPTION OF THE DRAWINGS

FIG. 1 shows a view of a roller brush station according to an exemplary embodiment of the present invention.

FIG. 2 shows a view of a dual-face prefinishing processing line with multiple roller brush stations.

FIG. 3 shows another view of a roller brush station.

FIGS. 4A and 4B show side and front views of a two-tone paint redistribution station according to an exemplary embodiment of the present invention.

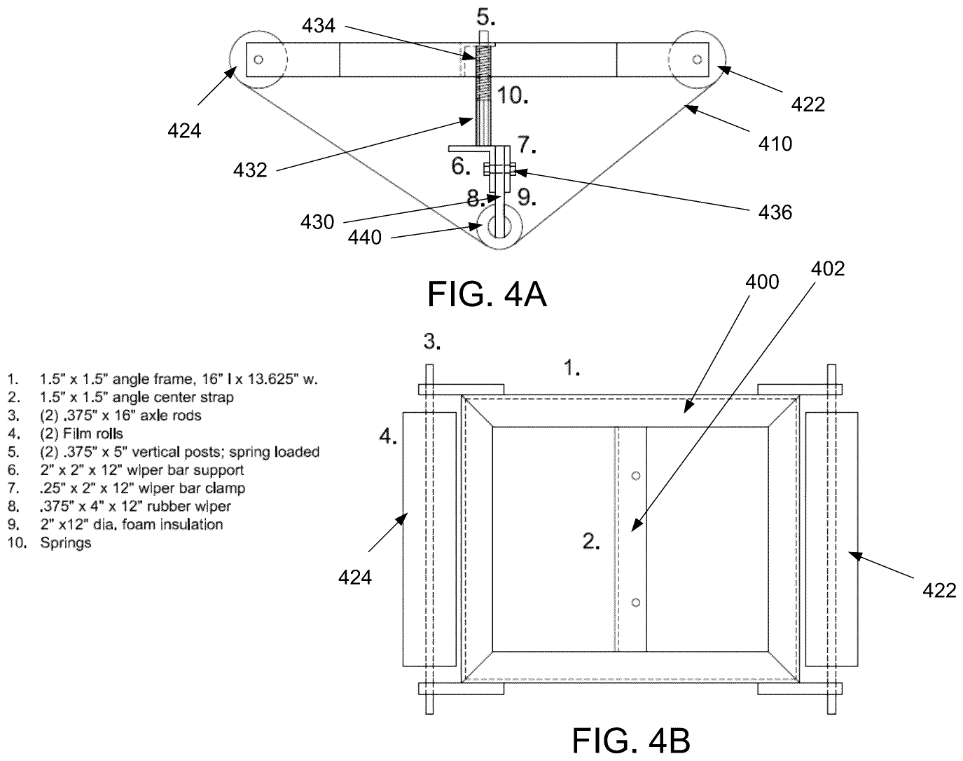

FIG. 5 shows a diagram of a process of creating a tone-tone finishing on a processing line with a two-tone paint redistribution station.

### DETAILED DESCRIPTION OF EXEMPLARY EMBODIMENTS

Engineered wood fencing panels and pickets, and methods of production, are described in U.S. patent application Ser. No. 16/189,995, “Engineered Fence Panels and Process,” filed Nov. 13, 2018, published as US 2019/0248039 A1 on Aug. 15, 2019, which is incorporated herein in its entirety by specific reference for all purposes. The fencing substrate comprises engineered wood products (including, but not limited to, oriented-strand board (OSB), fiber strand, or laminated strand lumber, and the like).

In several exemplary embodiments, the present invention comprises methods of applying a finish or paint coating in a finishing or prefinishing process for an engineered-wood siding board, plank, piece, panel, or trim, or a fencing panel or picket (a reference to any one of these forms should be construed to include any and all of these forms).

In one exemplary OSB manufacturing process, the substrate is produced with a cedar or similar texture on one side and “screen back” on the other side. The “screen back” texture (e.g., a corrugated or pixilated appearance) is the result of pressing the OSB board with two paper overlays, one on the front and one on the back. The unfinished mat (comprised of paper overlays and resin-rich wood flakes) is conveyed through the manufacturing line on a porous metal screen, including into the industrial press that applies heat and pressure to convert the mat into a unified piece of OSB with paper overlays. During the process of compressing the flakes and paper together, the porous metal screen also gets pressed by the bottom press plate into the back side of the substrate, thereby pressing the screen's pattern into the back of the substrate. This pattern remains in the substrate after subsequent processing, such as cutting the substrate into fence pickets or panels, or siding pieces, boards, planks or panels.

Boards, planks, panels, fence panels and pickets often are finished prior to being sold (i.e., prefinished, or pre-painted). Such finishing includes two-tone prefinishing, i.e., where two colors or two distinct color tones are applied. In typical finishing processes, the screen-back appearance described above often is accentuated and becomes more visible due to a semi-transparent topcoat of paint, which is applied to the back of the picket or panel, pooling in the deeper recesses of the screen pattern as the plank, board, picket or panel travels down the coating line to the finishing oven. Accordingly, there is a need for a prefinishing process for a engineered-wood product with a coating that addresses the screen-back appearance issue without modifying the engineered wood substrate production process.

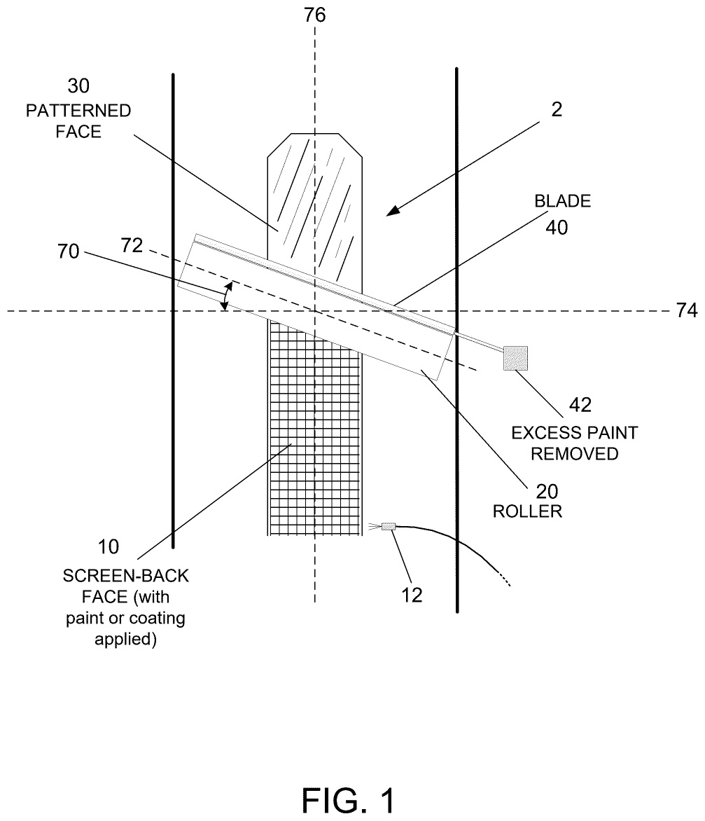

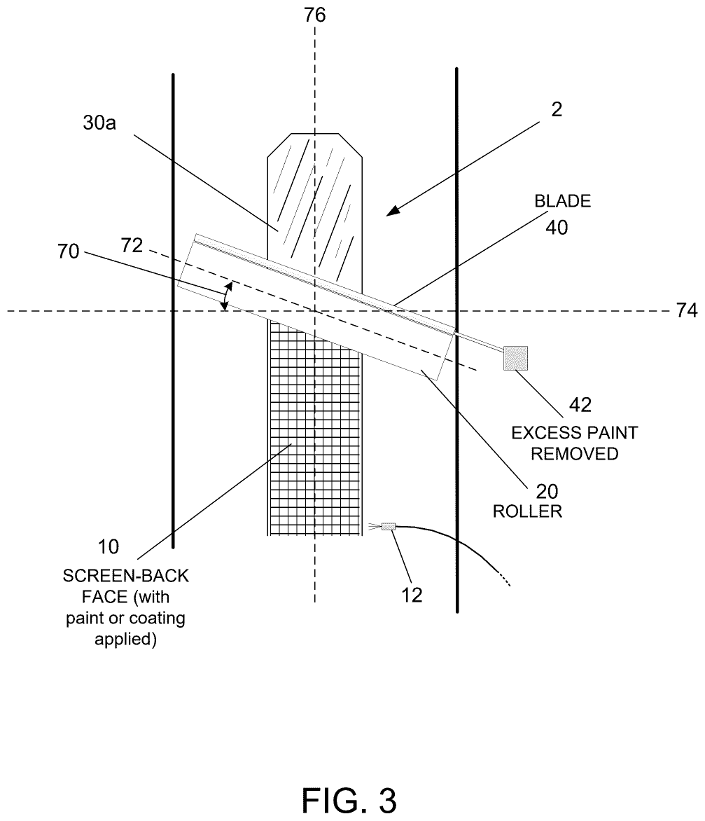

In several exemplary embodiments, the present invention comprises an apparatus and method of applying a finish or paint coating in a prefinishing or finishing process for a fencing panel or picket that disguises the screen-back texture of the substrate. As seen in FIG. 1, in one exemplary embodiment, after paint or similar coating is applied (such as by one or more spray nozzles 12) to a face, e.g., the screen-back patterned face 10, of the fence picket 2 (or fencing product), the fence picket passes under a roller, brush, or roller brush 20 or similar paint applicator while the paint is still wet. The roller/brush 20 removes some of the paint and applies an angled pattern to the face 30, which disguises the screen-back texture of the substrate. In some embodiments, paint may be previously applied to the roller/brush 20, with some paint applied to the screen-back face 30a, as seen in FIG. 3. In several embodiments, no paint is previously applied to the roller/brush; i.e., the roller/brush is not used to apply paint to the board, panel or picket, just remove some of the paint and apply a pattern.

As seen in FIG. 1, the roller/brush is angled with respect to the board, panel or fence picket as the product passes under the roller/brush on the finishing line. In one exemplary embodiment, the angle 70 ranges from 0 degrees to approximately 45 degrees (i.e., the longitudinal axis 72 of the roller/brush with respect to a line or lateral axis 74 across the width of the picket and/or finishing line, which is at right angles to the longitudinal axis 76 of the board/panel/picket and/or finishing line). In a further exemplary embodiment, the angle ranges from approximately 10 degrees to approximately 25 degrees. In a preferred embodiment, the angle ranges from approximately 12 degrees to approximately 20 degrees. As a result, the roller/brush applies a variable pattern at an angle along the length of the face, with minimal paint flow after brushing. In particular, the variable length and spacing of the linear aspects of the variable pattern applied by the roller/brush disguises the more orthogonal patterning caused by the standard application of paint to the screen-back face. The angle affects the effectiveness of the “disguising” effect to a person viewing the picket as installed (i.e., with the picket longitudinal axis vertical). The picket may then pass through an oven or drying station to dry the paint and the angled pattern on the face.

The angle of the brush/roller generally results in a complementary angle for the angle of the linear elements of the angled pattern with respect to the lateral axis of the board/panel/picket. Accordingly, the angle of the linear elements of the angled pattern with respect to the longitudinal axis of the picket is generally the same as the roller/brush angle described above. The angle(s) of the linear elements often will not be exact due to the variability in movement of individual brush or roller elements as the picket passes underneath. This variability promotes the “disguising” effect described herein.

In several embodiments, a blade or scraper 40 may be positioned along the roller brush 20 to remove excess paint from the brush as it removes paint from the picket face. The excess paint is metered off one end of the blade, and processed for re-use or disposal.

Patterning using the angled brush may be applied to a single face of the board/panel/picket (e.g., the screen-back side), or to both faces. First, paint (primer/sealer) coating is sprayed on the side edges and ends of the picket. In some embodiments, multiple layers or increased thicknesses of paint (primer/sealer) coating may be applied in some areas, such the bottom and top ends, or along the edges of any dog-ears. After drying, a base coat may be applied to each face and all edges, with the first face and edges dried before flipping the picket and application of the base coat to the second face and edges. The top-coat or patterned paint or coating then is sprayed on the first or second face and edges of the picket at a paint booth or station, and passes under a brush station as described above, where the pattern is applied by the roller brush, and then dried in an oven. After drying, the picket is flipped, and the opposite face is painted at a paint booth or station. If the opposite face is also to be patterned, the picket then passes under a brush station as described above. After drying, the picket is then further processed and packaged as needed.

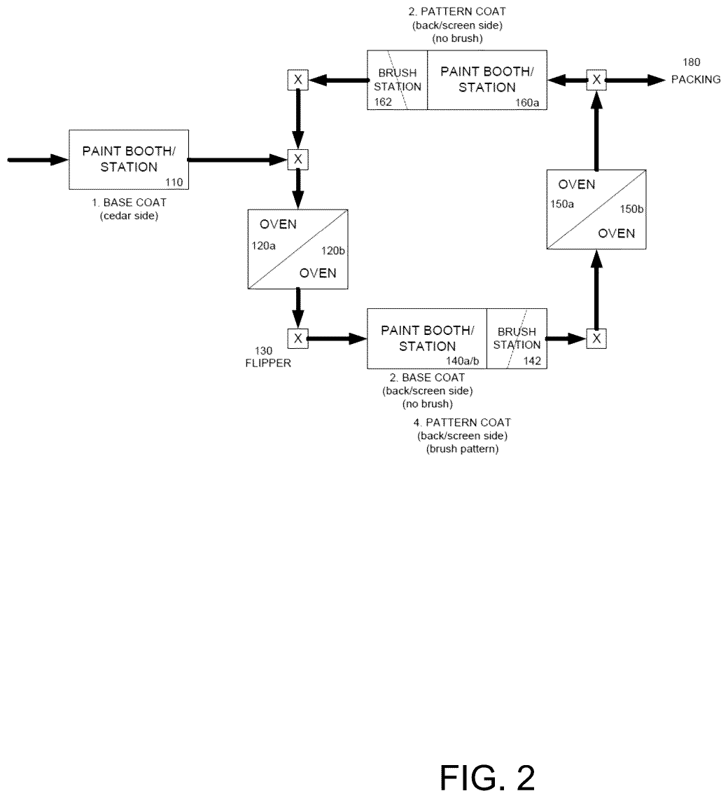

FIG. 2 shows an example of a “stacked” prefinishing line where both faces are treated with a series of stacked ovens and stacked paint booths/stations. After applying paint to the edges and ends of the pickets, the first face (which may be the cedar or embossed side) receives a base coat by standard application at a paint booth/station 110, is dried in an oven 120a, and then flipped 130 to the second face (which may be the screen-back face), which similarly receives a base coat by standard application (without brushing) at a paint booth/station 140a, and is dried in an oven 150a. The picket then proceeds to a paint booth/station 160a with accompanying brush station 162 for applying a coating layer by standard application over the base layer on the second face, followed by applying a pattern with a roller/brush (as described above) to the second face. The picket is then is dried in an oven 120b (stacked with oven 120a), and flipped 130 so the first side is up. The picket then proceeds to paint booth/station 140b (which may be stacked with paint booth/station 140a) with accompanying brush station 142 for applying a coating layer by standard application over the base layer on the first face, and then applying a pattern to the first (e.g., cedar-textured pattern) face with a roller/brush (as described above). The picket then is dried in oven 150b (which may be stacked with oven 150a), and then sent for further processing/packaging 180. A finishing line as described above may have independent units spaced appropriately, or, as shown, multiple ovens may be stacked so that heat is shared between ovens in the stack for greater operational efficiency. Similarly, paint booths/stations may be stacked for operational efficiencies.

Accordingly, the present invention provides an exterior, engineered fence picket or panel with enhanced durability, weather-resistance, fade resistance, and a single- or dual-sided aesthetic appearance at a lower cost and faster installation as compared to prior art fences and materials.

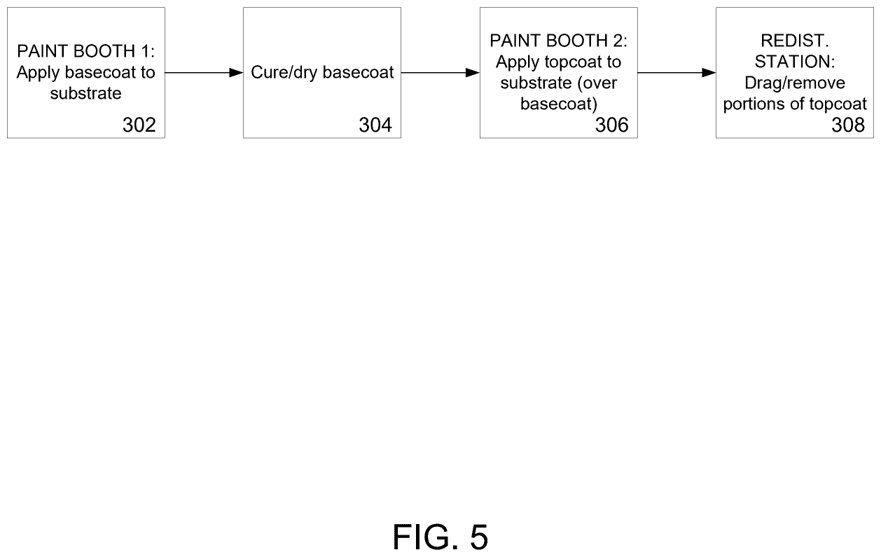

In a further embodiment, boards, panels, planks and/or pickets are subject to two-toned processing in a different manner. As seen in FIG. 5, the process first applies a base coat paint layer (by spraying or otherwise) of a first color in a first paint booth 302 on a product face, which can be smooth or textured, such as the cedar or similar texture described above, then allows the basecoat to dry or be cured (if needed) 304, and then applies a top coat paint layer (by spraying or otherwise) of a second color in a second paint booth 306 over the base coat paint layer. While the top coat is still wet, the painted product then is conveyed into the paint redistribution apparatus, which moves all or substantially all of the topcoat paint from the high points or “peaks” of the textured surface and into the low points or “valleys” thereof, and/or removes portions of the topcoat from the product as well 308, as described in more detail below. The areas where the topcoat is removed expose the basecoat, thereby resulting in a two-tone appearance.

As seen in FIGS. 1A-B and 2, the process first applies a base coat paint layer (by spraying or otherwise) of a first color in a first paint booth on a product face, which can be smooth or textured, such as the cedar or similar texture described above, allows the basecoat to dry or be cured (if needed), and then applies a top coat paint layer (by spraying or otherwise) of a second color in a second paint booth over the base coat paint layer. While the top coat is still wet, the painted product then is conveyed into the paint redistribution apparatus shown in FIGS. 1A and B.

The paint redistribution apparatus comprises a frame 400 with a PET (polyethylene terephthalate) film 410 of appropriate thickness suspended below and between a feed roller 422 and a collection roller 424. The PET film runs from the feed roller over a “blade” or arm 430 extending downward from a frame cross-bar 402 with a circular or curved section of foam or rubber 440 covering the bottom edge of the blade as a contact point. The blade may be a thin piece of wood, or may be semi-flexible or flexible (e.g., rubber) During application, the rollers are fixed/locked and do not rotate, and the PET film 410 has some slack and is not fully taut, so the film has limited movement as the product moves underneath the paint redistribution apparatus. As the film 410 comes into contact with the wet top coat paint at the point where the foam or rubber contact point comes closest to, or in near or light contact with, the product surface, the film 410 sticks to the top coat and is pulled or dragged in the direction the product moves. The front section of the film (between the feed roller and the foam or rubber contact point 440) becomes taut, and the back section of the film closest to the foam/rubber remains in contact with the top coat for a short distance behind the foam/rubber due to the drag effect. This extended contact drags or moves portions of the topcoat further down the product, and also can remove portions of the topcoat from the surface of the product.

When used with a basecoat and topcoat on the cedar or other textured surface of the substrate, the apparatus drags and moves all or substantially all of the topcoat paint from the high points or “peaks” of the textured surface and into the low points or “valleys” thereof, and/or removing portions of the topcoat. The areas where the topcoat is removed expose the basecoat, thereby resulting in a two-tone appearance. The topcoat may be a darker or lighter color than the basecoat, or a similar color but with a different tone or appearance. In an exemplary embodiment, the basecoat is a lighter color than the topcoat, which provides for additional contrast between the high points and low points.

The position of the blade 430 can be adjusted vertically up and/or down (such as by adjusting the screws 436 connecting the vertical posts 432 to the blade or arm and to the frame of the apparatus) to change the amount of contact and/or pressure applied by the foam/rubber contact point 440 (which moves in conjunction with the blade). The vertical posts 432 may be spring loaded 434 to help provide the proper amount of pressure to the film. This also can allow the blade to be moved up to allow replacement of rolls of film (i.e., the older used roll is removed from the collection roller, and a new roll of film is placed on the feeder, with the leading edge of the film pulled and connected to the collection roller; the blade can then be moved down while the feeder is unlocked to allow the film to unroll into position to contact the face of the piece).

In general, the greater the amount of contact/pressure, the greater the amount of topcoat that will be moved and/or removed. Similarly, the level of tautness of the film affects the distance and the length of the back section of the film that remains in contact with the topcoat. Tautness can be adjusted by the amount of film allowed to unwind from the feeder roll before it is locked.

After the product has been processed, the PET film that has been used to move or remove topcoat paint (or where one or more holes have been worn in the film by use) can then be moved back and away from the foam/rubber contact point by unlocking the roller or rollers, and rotation of the collection roller after the product has passed through the apparatus. This process causes the used portion of the film to be rolled up onto the collection roller, while fresh, unused film is fed from the feeder roller. Depending on the topcoat being used and the timing of the process, the used portion of the film may be rolled up after a single product is treated, or after two or more products are treated.

The thickness of the PET film also has an impact on the appearance of the two-tone effect. A thin, lighter film will remove less topcoat, while a thicker, heavier film will remove more topcoat. In general, the thickness of the PET film can range from 1 mil to 10 mils. In a preferred embodiment, the thickness of the PET film is 4 mils, which Applicant has found provides a good, repeatable aesthetic appearance of the two-tone effect.

In some alternative embodiments, a material other than PET film may be used, including, but not limited to, other forms of plastic, metallic foil, cloth, fabric, paper, kraft paper, or the like.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for applying paint or coating on a prefinishing or finishing line, comprising:
one or more first applicators configured to apply a coating or paint to a face of a siding or fencing component conveyed on a prefinishing or finishing line;
a second applicator configured to apply an angled pattern in the applied coating or paint while still wet as the fencing component moves past the second applicator on the prefinishing or finishing line.

2. The system of claim 1, wherein the second applicator comprises a roller, brush or roller brush that comes into contact with the applied coating or paint on the face of the fencing component.

3. The system of claim 2, wherein the second applicator removes part of the applied coating or paint.

4. The system of claim 2, wherein additional paint or coating is applied by the second applicator.

5. The system of claim 2, wherein no additional paint or coating is applied by the second applicator.

6. The system of claim 2, wherein the second applicator has a longitudinal axis, and the fence component has a lateral axis orthogonal to a longitudinal axis, and the longitudinal axis of the second applicator is at an angle with respect to lateral axis of the siding or fence component.

7. The system of claim 6, wherein the angle is in a range of approximately 10 degrees to approximately 25 degrees.

8. The system of claim 1, wherein the siding component is a siding piece, plank, board, panel, or trim.

9. The system of claim 8, wherein a face of the siding component comprises a texture with high points and low points covered with a basecoat of paint underlying a topcoat of paint, and further comprising:
a paint redistribution apparatus with a suspended PET film with a front side and a back side, wherein a foam contact head on the back side holds a portion of the PET film in contact with the textured face of the siding component as the siding component passes underneath the PET film and foam contact head and thereby moving and/or removing portions of the topcoat form some or all of the high points of the texture.
